(19) United States
(12) Patent Application Publication
(10) Pub. No.: US 2026/0121314 A1
(43) Pub. Date: Apr. 30, 2026

(54) Electrical Connector for Mating with a PCB and an Electrical Connector Assembly

(71) Applicants: TE Connectivity Solutions GmbH, Schaffhausen (CH); Tyco Electronics (Shanghai) Co. Ltd., Shanghai (CN)

(72) Inventors: Deepan Ponraj MUTHUPANDI, Bangalore (IN); Clinton PEREIRA, Bangalore (IN); Rajendra PAI, Bangalore (IN); Jiangtao KANG, Shanghai (CN)

(73) Assignees: TE Connectivity Solutions GmbH, Schaffhausen (CH); Tyco Electronics (Shanghai) Co., Ltd., Shanghai (CN)

(21) Appl. No.: 19/365,247

(22) Filed: Oct. 22, 2025

(30) Foreign Application Priority Data
Oct. 24, 2024 (IN) 202441080986

(51) Int. Cl. H01R 12/70; H01R 12/71; H01R 13/05; H01R 13/627; H01R 13/64

(52) U.S. Cl. CPC H01R 12/7023; H01R 12/718; H01R 13/055; H01R 13/6273; H01R 13/64

(57) ABSTRACT

Electrical connector for mating with a PCB, comprising a housing and a plurality of terminals arranged within the housing. Each terminal of the plurality of terminals comprises a contacting part that is configured to contact a tab that is located on the PCB. Each terminal further comprises a terminating part that is configured to terminate a wire. The housing comprises a plurality of connection openings that is configured to enable access to the plurality of terminals from outside the housing from two different directions.

### CROSS-REFERENCE TO RELATED APPLICATION

This application claims the benefit of Indian Patent Application number 202441080986 filed on Oct. 24, 2024 in the Indian Patent Office, which is hereby incorporated by reference in its entirety.

### BACKGROUND OF THE INVENTION

The present invention relates to an electrical connector for mating with a PCB and an electrical connector assembly with the electrical connector.

Electrical connectors are commonly used to establish an electrical connection, for example by mating the electrical connector with a header soldered to a printed circuit board (PCB). Furthermore, when powering a DC motor, for example, the connector of the motor has to be connected to the motor controller PCB. Usually, magnet wires are used for the connection and the termination is typically done by soldering the wires to the connector.

It is difficult to use these kinds of connectors in tight spaces, as commonly known headers take a lot of space and the connector and the PCB cannot be accessed easily. With the on-going miniaturization of electrical parts and the need to automate many processes—like in the motor production, for example—there is no flexibility in using the aforementioned connectors and the connection is further at risk of damaging the pins when misaligning the connector and the header pins.

There is therefore a need for the present invention to provide an electrical connector for mating with a PCB and an electrical connector assembly with said electrical connector that can be used in appliances with little available space as well as ease and simplify the termination of wires and the mating of the connector.

### SUMMARY OF THE INVENTION

This need is met by an electrical connector for mating with a PCB, comprising a housing and a plurality of terminals arranged within the housing, wherein each terminal of the plurality of terminals comprises a contacting part that is configured to contact a tab that is located on the PCB, and a terminating part that is configured to terminate a wire, and wherein the housing comprises a plurality of connection openings that is configured to enable access to the plurality of terminals from outside the housing from two different directions.

The need is further met by an electrical connector assembly with an electrical connector with a plurality of wires, a PCB, and a plurality of tabs.

The above solution is advantageous as it provides flexibility in mating directions and means to connect to a PCB without needing a header, making the electrical connector adaptable to different, especially small and hard-to-reach, spaces or assembling conditions. Further, the above solution can be used in a fully automated motor production process.

The invention can be further improved by the following embodiments, which are advantageous in themselves and which can be arbitrarily combined with one another.

The electrical connector may be used for mating with a DC motor controller PCB, for example a motor controller PCB that controls the three phases of a brushless DC motor. The electrical connector may also connect to PCBs with different uses, of course.

As is common with motors, or also with transformers or generators, the electrical connector may be used with magnetic or magnet wires, especially without the need to pre-strip the wires. The magnet wire can be made of metal, for example unalloyed and pure metal like copper or aluminum.

Each of the wires may be connected to each terminal of the plurality of terminals. The wire may be terminated in the terminating part of the terminal. The term “terminate” is used to describe any work done or performed to the end of a wire.

Each terminal may extend longer in one direction than in other directions, defining a longitudinal direction along the length of the terminal.

The terminating part may comprise a wire receptacle to receive a wire or wire end. In one embodiment, the terminating part may comprise two wings extending from a base, especially a joint base, forming an open wire receptacle. The two wings may be angled away from each other. The two wings may both have the same geometric shape and may be rectangular, for example. The two wings may also take on other geometric shapes and can be round, elliptic, a half-circle, square and/or, at least partially, comprise notches along one or more edges, for example.

In another embodiment, the two wings may comprise different designs from each other.

The terminating part may be configured as an insulation displacement contact (IDC) to connect to the conductor of an insulated wire. An IDC establishes an electrical connection by pushing a sharpened blade or blades through the insulation and there is no need to strip the wire of insulation before connecting. In other words, no pre-stripping of the wire is needed.

The terminating part may comprise sharp protrusions—at least in sections—acting as the blades that push through the insulation of the inserted wire or wire end.

In one embodiment, the wings may each comprise sharp edges and/or protrusions extending towards an inserted wire. The protrusions may be configured as serrations to cut through an insulation of a wire. The wire may be inserted or terminated with force to enable a full connection to the terminal, for example by crimping the wire to the terminating part. The terminating part may comprise an insulation section to hold the insulation of the wire for strain relief. The crimp-on process is simple, quick and easy to repeat. The crimp connection provides a consistent and vibration-resistant connection.

In another embodiment, the wire end may be soldered to the terminating part of the terminal. Soldering provides a reliable and strong connection and can be used with a wide variety of wire types and sizes.

The contacting part of the electrical connector may comprise a contacting base. The contacting base can be the same as the base of the terminating part that connects the two wings. The contacting base of the contacting part may be an extension of the base of the terminating part. The contacting base may be located directly next to the base of the terminating part.

The contacting base of the contacting part may connect two parallel arms extending from the base in a direction perpendicular to the longitudinal direction of the terminals. The two arms may converge as they extend further. The ends of the two arms may flare outwards again after the two arms converged. In other words, the ends diverge, forming a fork-shaped contacting part.

The contacting part may be U-shaped, especially Omega-shaped.

The contacting part may comprise a notch at each end of the two arms to make the ends more flexible for easier mating with the PCB.

The contacting part may further comprise an opening, in which tabs of the PCB can be inserted, especially between the two arms, for example where the two arms converge. The tabs may be inserted into the contacting part from a direction perpendicular to the longitudinal direction, for example the direction pointing from the ends of the arms towards the contacting base. The tabs may be inserted along the longitudinal direction of the terminal, towards the U- or Omega-shape of the contacting part.

The housing that houses the plurality of terminals may be box-shaped or cuboidal, which means that the housing can be formed like a flat cuboid with two flat sides and four narrow sides. This shape streamlines and simplifies the production of the electrical connector.

The housing can be molded onto the plurality of terminals, which allows for an integrated design to reduce the number of parts.

The housing may comprise receptacles or chambers, in which the plurality of terminals, or each terminal of the plurality of terminals may be received inside the housing.

In one embodiment, the housing can comprise a plurality of insertion openings to insert the plurality of terminals into the receptacles. The insertion openings may be rectangular-shaped and wide enough to insert a terminal into each insertion opening.

The insertion openings may be located on a narrow side of the housing facing the longitudinal direction. The plurality of terminals may also be inserted from a direction perpendicular to the longitudinal direction of the terminals.

The housing may be configured to have a lid on a side, for example a flat side, of the housing that can be removed to insert the terminals from the direction perpendicular to the longitudinal direction of the terminals.

At least a part of the plurality of connection openings or interfaces that is configured to enable access to the plurality of terminals located inside the housing, especially the contacting part of the terminals, from outside the housing may be located opposite the insertion openings that are facing the longitudinal direction of the terminals. At least a part of the plurality of connection openings may be located on a side perpendicular to the side with the insertion openings.

The connection openings may enable access to the plurality of terminals from at least two different directions. The directions may be perpendicular to each other, making the electrical connector a bidirectional connector. The electrical connector can thus be mated with a PCB along both connection directions or mating directions.

One mating direction can be the same as the longitudinal direction along the length of the terminals. The other mating direction can be perpendicular to it.

The plurality of connection openings may be located on at least one side of the housing. For example, a connection opening can be located on a flat side of the housing and/or on a narrow side of the housing.

The side of the housing comprising at least one of the plurality of connection openings may face the longitudinal direction of the plurality of terminals, which is to say, the plane of that side of the housing can comprise the longitudinal direction as a normal. A side of the housing with at least one of the plurality of connection openings may also comprise a normal that is perpendicular to the longitudinal direction of a terminal.

Two connection openings may be assigned to each terminal of the plurality of terminals. In other words, two connection openings may be assigned to the one, especially the same, terminal and one terminal may be assigned to two different connection openings.

In one embodiment, the electrical connector can comprise at least one connection opening on a flat side of the housing and at least one connection opening on an adjoining side, for example an adjoining narrow side, of the housing. The connection openings may be perpendicular to each other and may be connected, creating a large opening extending from one side of the housing over the edge of the housing to the adjoining side.

To hold the electrical connector to the PCB, the electrical connector may comprise a retainer element.

The retainer element may comprise two elastically deflectable extensions that protrude along a mating direction, so the two elastically deflectable extensions may protrude towards a connector or PCB to which the electrical connector is to be mated and/or along and/or perpendicular to the longitudinal direction of the terminals.

The two elastically deflectable extensions may be configured as two elongated arms that are attached on two sides of the housing, for example, on two opposite narrow sides of the housing. The two extensions may be elastically deflectable in a direction away from the housing.

In another embodiment, the retainer element may comprise one or more, for example two, screw-like cylindrical protrusions. The cylindrical protrusion may comprise a notch along the central axis of the cylindrical protrusion, parting the cylindrical protrusion into two elastically deflectable extensions. The two elastically deflectable extensions may be deflectable inwards, i.e. towards each other.

The retainer element may be located on the same narrow side of the housing as the connection openings, i.e. the side of the housing facing the insertion direction of the terminals and/or the longitudinal direction of the terminals.

The retainer element may be used for self-aligning and/or blind mating, so the electrical connector may be guided by the retainer element while mating with the PCB without the operator needing to look.

Each elastically deflectable extension may comprise a latch to hold the electrical connector to the PCB. The latch—or nose or retainer tab—may protrude from one side of the elastically deflectable extension. In a relaxed state, that means in a not-deflected state, the latch may extend wider than the diameter of a mounting recess, hole or opening on the PCB to stop the connector from moving in the direction opposite the mating direction. In the relaxed state of the elastically deflectable arms, after mating to a PCB, the retainer element or latch can lock the electrical connector in place.

The retainer element may hold the electrical connector in a horizontal mounting position, which means having a flat side of the housing abut to a flat side of the PCB.

The retainer element may hold the electrical connector in a vertical mounting position, which means having a narrow side of the housing abut to a flat side of the PCB.

The retainer element may comprise a release end or release arm to release the electrical connector from the PCB. The release end releases the electrical connector and the PCB, severing the connection between electrical connector and PCB.

The release end may be a protrusion on the other end of the retainer element, i.e. the end that does not protrude in mating direction, but in the direction opposite to it. The release end may be pushed inwards, towards the housing to deflect the latch on the other end of the elastically deflectable extension outward, and thus releasing the connector.

In one embodiment, for example the embodiment with the cylindrical protrusion retainer element, the latches and the release end are formed by one element at the same end. The two latches of the cylindrical extension can be pushed towards each other to release the connector.

In another embodiment, the electrical connector may comprise a second retainer element, wherein the second retainer element is located on at least one different side of the housing than the first retainer element. For example, one retainer element with two elongated arms on two opposite sides of the housing may protrude in a direction perpendicular to the longitudinal direction of the terminals, wherein the second retainer element may protrude along the longitudinal direction of the terminals.

The electrical connector may thus comprise two retainer elements to enable a flexibility in mating, especially in choosing the mating direction, and at the same time securing the electrical connector once mated.

In one embodiment, the two retainer elements can comprise the same design but rotated, securing the electrical connector in two different mating directions. In another embodiment, the two retainer elements may each be configured differently due to space issues or material needs, with the housing being secured in one mating direction by the retainer element with one or two cylindrical protrusions and in the other mating direction by the retainer element with two elastically deflectable extensions on two opposite sides of the housing.

The electrical connector may comprise a terminal position assurance (TPA) to ensure that the plurality of terminals, with the terminated wires, are fully inserted into the housing and to prevent the wrong placement of each terminal.

The TPA may comprise a protrusion extending towards the housing for each terminal of the plurality of terminals, especially along the length of each terminal.

In another embodiment, the TPA may be integral with the housing, so that housing and TPA are formed as one part, reducing the number of parts effectively.

The electrical connector, especially the housing, may comprise at least one polarization pin that protrudes towards the PCB to prevent wrong mating.

The polarization pin may be an extension that fits onto the PCB in only one direction. The extension may be cylindrical. In one embodiment, the retainer element or at least part of the retainer element may act as a polarization pin, for example at least one of the two cylindrical protrusions of a retainer element.

The PCB of the electrical connector assembly may comprise a plurality of recesses to fit at least part of the electrical connector, the retainer elements and/or the polarization pin or pins.

The electrical connector assembly may further comprise a plurality of tabs that comprise a rectangular connection portion. The rectangular connection portion may comprise rounded edges to ease the connection of the electrical connector. The plurality of tabs may each comprise a flat, blade-shaped or blade-type form.

Each of the plurality of tabs may comprise, or be configured as round pins instead of flat tabs, making the electrical connector more versatile to connect to different mating PCB.

### BRIEF DESCRIPTION OF THE DRAWINGS

The invention shall be explained in more detail hereafter by way of example with reference to the drawings. The feature combinations illustrated in the embodiments shown by way of example can be supplemented by further features in accordance with the above statements in correspondence with the properties of the invention required for a specific application. Individual features can also be omitted in accordance with the above statements from the embodiments described if the effect of these features is of no relevance for a specific application. The same reference numerals in the drawings are always used for elements having the same function and or the same structure.

In the drawings:

FIG. 1 shows a schematic view of an embodiment of the electrical connector;

FIG. 2 shows a schematic view of an embodiment of a terminal;

FIG. 3 shows a schematic front view of the terminal;

FIG. 4 shows a schematic view of the terminal crimp;

FIG. 5 shows a schematic view of the electrical connector with a retainer element;

FIG. 6 shows a schematic view of an embodiment of the electrical connector with multiple retainer elements and a TPA;

FIG. 7 shows a schematic exploded view of the electrical connector;

FIG. 8 shows a schematic sectional view of an embodiment of the electrical connector with TPA;

FIG. 9 shows a schematic exploded view of the electrical connector assembly with tabs and a PCB;

FIG. 10 shows an embodiment of the electrical connector assembly in the mounted state;

FIG. 11 shows a schematic side view of the electrical connector assembly in a mounted state;

FIG. 12 shows a schematic sectional view of the electrical connector assembly in the mounted state;

FIG. 13 shows the electrical connector assembly with an embodiment of the electrical connector and an embodiment of the PCB with solder tabs;

FIG. 14 shows an embodiment of the electrical connector assembly in the mounted state (vertical mounting);

FIG. 15 shows a schematic sectional view of an embodiment of the electrical connector assembly in the vertical mounted state;

FIG. 16 shows an exploded view of the electrical connector assembly for vertical mounting; and

FIG. 17 shows an embodiment of the electrical connector assembly with round pins instead of solder tabs.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

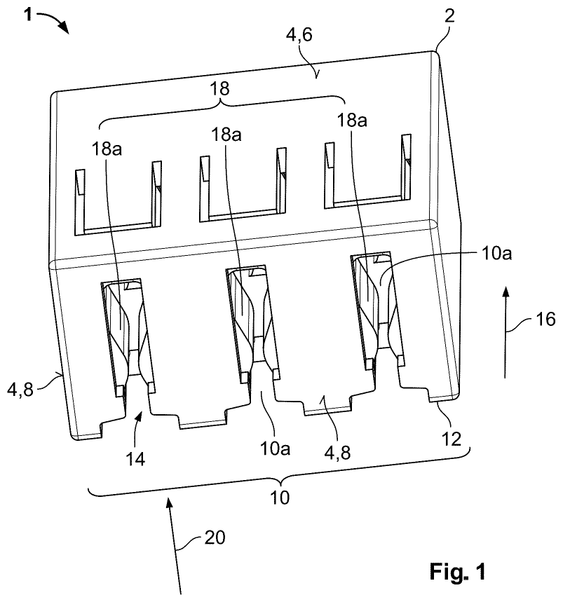

In FIG. 1, the electrical connector 1 is shown with a housing 2 that is box-shaped. The housing 2 can be cuboidal or a flat cuboid. The housing 2 can comprise multiple sides 4, two flat sides 6 and four narrow sides 8, wherein two of the sides 4 may each comprise connection openings 10a of a plurality of connection openings 10. The sides 4 comprising the connection openings 10a may be located at two sides 4 that are perpendicular to each other. The connection openings 10a may extend from one flat side 6 over the edge 12 to the adjoining narrow side 8, creating a continuous opening 14 over two sides 4.

At least one side 4 of the housing 2 can comprise a plurality of connection openings 10. The side 4 comprising the plurality of connection openings 10 can face the longitudinal direction 16 of a terminal 18a. The terminal 18a may be part of a plurality of terminals 18 arranged within the housing 2.

The plurality of connection openings 10 can thus be configured to enable access to the plurality of terminals 18 from outside the housing 2 from at least two different directions 16, 20.

The directions 16, 20 can be perpendicular to each other, making the electrical connector 1 a bidirectional connector.

The terminals 18a can be inserted into the housing 2. In one embodiment, the housing 2 can be molded onto the terminals 18a.

Each connection opening 10a that is arranged on a side 4 of the housing 2 may be assigned to a different terminal 18a.

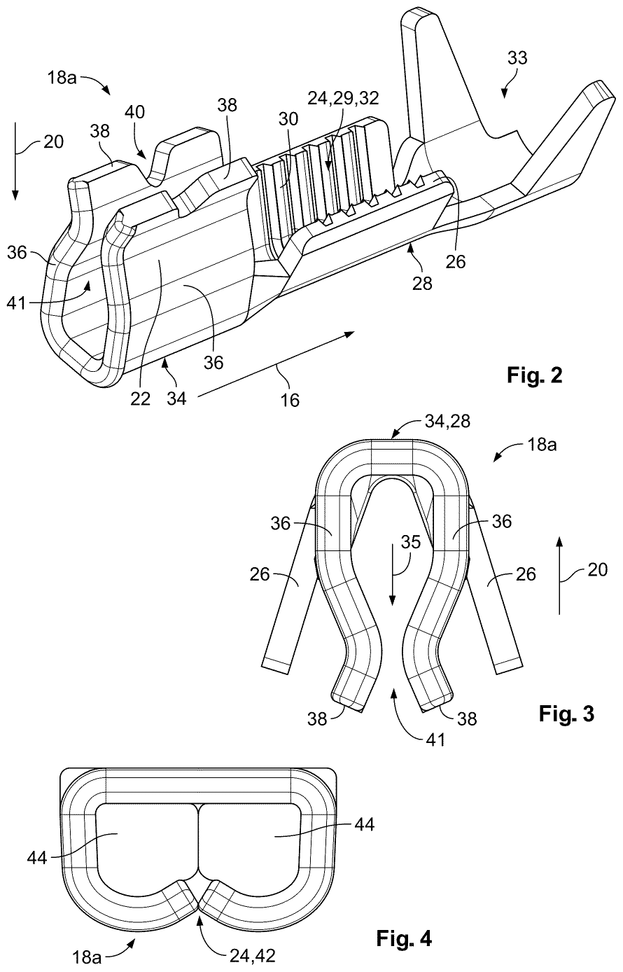

FIGS. 2, 3, and 4 each show an embodiment of a terminal 18a of the plurality of terminals 18. The terminal 18a may comprise a contacting part 22 and a terminating part 24.

The terminating part 24 can comprise two wings 26 connected through a base 28, forming a wire receptacle 29 that can be crimped (see also FIG. 4). The two wings 26 can each comprise blades, sharp edges and/or sharp protrusions 30, to use the wings 26 as IDC 32 to contact and terminate a wire or wire end (not shown) that can be inserted along the longitudinal direction 16 of the terminal 18a or from a direction 20 perpendicular to the longitudinal direction 16. The sharp protrusions 30 can be configured as serrations.

The terminating part 24 can further comprise an insulation section 33, in which the insulation of the wire is held without being pierced, for example, when crimping the wire. Alternatively, the wire can be soldered to the terminating part 24.

The contacting part 22 can be U-shaped, for example Omega-shaped. The contacting base 34 of the contacting part 22 may be the same as the base 28 of the terminating base and/or be located directly next to the base 28. The base 34 can connect two parallel arms 36 that extend from the base 34 in a direction 35 perpendicular to the longitudinal direction 16 of the terminal 18a. The two arms 36 can converge as they extend further and diverge at the end 38 so that the two arms 36 or the ends 38 of the two arms 36 flare outwards again. This eases connecting to a tab or a pin when mating later.

The contacting part 22 may also comprise a notch 40 which can make the contacting part 22, especially the ends 38 of the contacting part 22, more flexible to ease putting on the contacting part 22 onto a connecting tab or pin. The contacting part 22 may comprise an opening 41, in which a connecting tab or pin can be inserted.

The terminating part 24 may comprise a crimp 42 to terminate at least one wire 44. Alternatively, the wire 44 may be soldered to the terminating part 24. More than one wire 44 may be terminated within the terminating part 24 of the terminal 18a. Especially magnet wires 44 can be combined within the terminating part 24. The magnet wires 44 can be made of different materials like copper or aluminum.

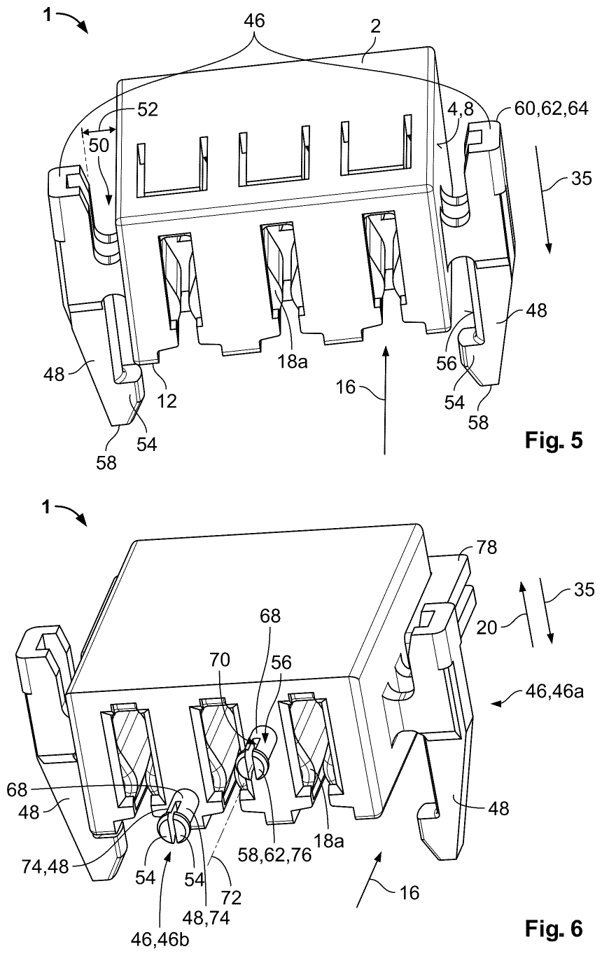

FIG. 5 shows an embodiment of the electrical connector 1 with a retainer element 46. The retainer element 46 may hold the electrical connector 1 to a PCB (not shown). The retainer element 46 may comprise two elastically deflectable extensions or arms 48 that can be attached to a side 4 of the housing 2 each, for example each on a narrow side 8. The arms 48 may protrude along a direction 35 perpendicular to the longitudinal direction 16 of the terminals 18a. The arms 48 may extend over the edge 12 of the housing 2. The same elongated arms 48 may comprise an attachment section 50, so that the extensions 48 are at a distance 52 to the side 4 of the housing 2, enabling the elastic deflection of the extension 48.

The retainer element 46 or the extensions 48 may comprise a latch 54—or a nose or a retainer tab—that protrudes from one side 56 of the elastically deflectable extensions 48 towards the housing 2. The nose 54 can taper along the direction 35 perpendicular to the longitudinal direction 16 of the terminals 18a at one end 58 of the extensions 48.

On the other end 60 of the extensions 48, the retainer element 46 or each arm 48 of the retainer element 46 may comprise a release end 62 or a release arm that can release the electrical connector 1 from the PCB (not shown) once it's mated. The release arm 62 may be a protrusion 64 that protrudes in the direction 20 opposite the direction of extension 35 of the arms 48. The protrusion 64 of each arm 48 may be pushed towards the housing 2 to release each latch or nose 54 from a holding element or recess (not shown) of the PCB.

FIG. 6 shows another embodiment of the electrical connector 1 with two retainer elements 46. An embodiment of the retainer element 46 may comprise one or two cylindrical protrusions or extensions 68. The two cylindrical protrusions 68 may extend along the longitudinal direction 16 of the terminals 18a. The retainer element 46 or each extension 48 of the retainer element 46 may comprise a slit 70 along the center axis 72 of the extension, partially separating two arms 74 of the cylindrical protrusion 68 that can be deflected inwards towards each other. At the end 76 of the cylindrical protrusion 68, the retainer element 46 may comprise a latch or a nose 54 to secure the electrical connector 1. The nose or latch 54 may also be the release end 62 to release the electrical connector 1 from securement. That means that, in this embodiment, the latch 54 and the release end 62 are formed by one element.

In this embodiment, one retainer element, i.e. the first retainer element 46a is located on a different side 4 than the other retainer element, for example the second retainer element, 46b and especially facing or extending towards a different direction 35 than the other retainer element 46b, enabling the fixing of the electrical connector 1 against movement along two directions 16, 20 preferably in the two mating directions or connection directions 16, 20.

Further, a TPA 78 can be used to ensure the correct placement of the terminals 18a. The TPA 78 abuts to a side 4, for example a narrow side 8 of the housing 2, and can be inserted into the housing 2 along the longitudinal direction 16.

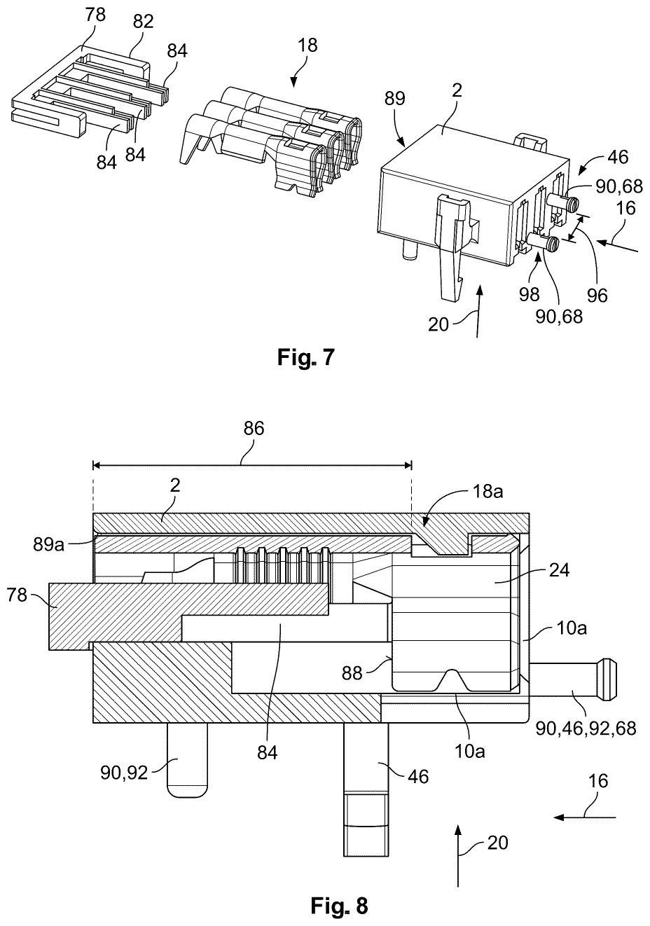

FIGS. 7 and 8 show an exemplary placement of the TPA 78. The TPA 78 may comprise a frame 82 that can be U-shaped and can hug the housing 2 when mated.

The TPA 78 may comprise protrusions 84 that extend along the longitudinal direction 16 of the terminal 18a. To ensure the correct placement of the terminals 18a, the TPA 78 or the protrusions 84 of the TPA 78 may have a set length 86 that may be configured to abut with the contacting part 24, for example the back 88 of the contacting part 22, only when the terminal 18a is correctly placed within the housing 2, wherein the back 88 is used to describe the side 88 of the contacting part 22 that does not face a connection opening 10a.

The terminal 18a may be inserted through an insertion opening 89a which can be part of a plurality of insertion openings 89.

FIGS. 7 and 8 further show an embodiment of the electrical connector 1 with a polarization pin 90. The polarization pin 90 may be a cylindrical extension 92 that may protrude in any one of the mating directions 16, 20. The polarization pin 90 may fit into a polarization recess (not shown on the PCB onto which the electrical connector 1 is to be mated and may be configured to only fit in one direction to ensure the correct orientation 94 of the electrical connector 1.

The retainer element 46 with the cylindrical protrusions 68 may also be configured to act as a polarization pin 90 by placing the two cylindrical protrusions 68 at a set distance 96 and a set orientation 98.

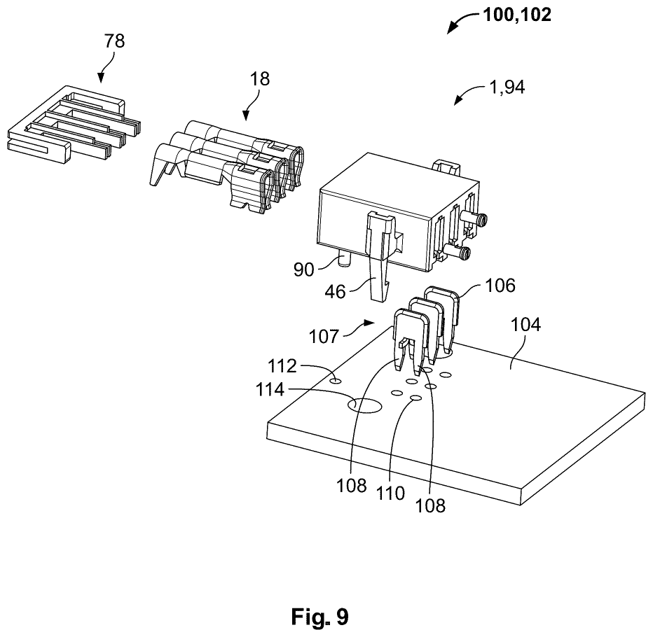

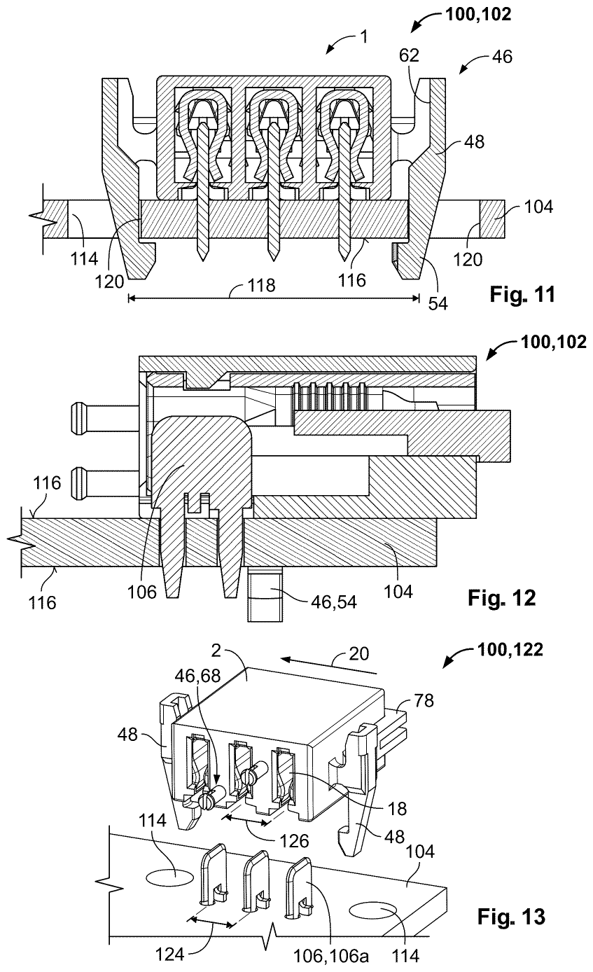

FIGS. 9 to 17 show the electrical connector assembly 100 with an electrical connector 1 as described above.

In FIGS. 9 to 13 the electrical connector 1 is shown in a horizontal mating state or position 102 wherein the electrical connector 1 is connected horizontally to the PCB 104 that comprises a plurality of tabs 106.

The electrical connector 1 with the plurality of terminals 18 and the TPA 78 may already be assembled and then placed on top of the PCB 104 to connect with the plurality of tabs 106.

Each tab 106a may comprise a connection portion 107 that can be rectangular with rounded edges. Each tab 106a may comprise two legs 108 that may be placed on the PCB 104, especially inside mounting holes 110 of the PCB 104. The plurality of tabs 106 may be soldered to the PCB 104. The PCB 104 may comprise at least one polarization recess 112 for the polarization pin 90 to fit in a predetermined orientation 94. The PCB 104 may also have retainer recesses 114 into which at least one retainer element 46 may fit.

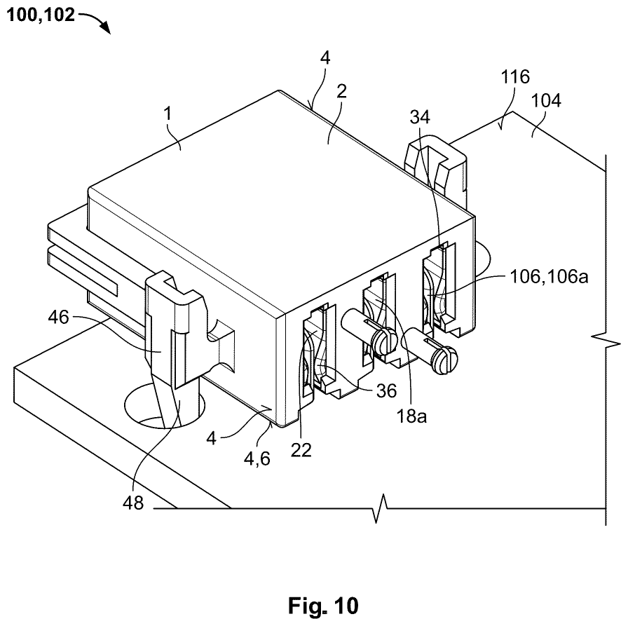

FIG. 10 shows the electrical connector assembly 100 wherein the electrical connector 1 is mated to the PCB 104 and secured by the retainer element 46. The electrical connector 1 is mounted horizontally onto the PCB 104 which means that the broader flat side 6 of the housing 2 abuts or rests on the flat or broader side 116 of the PCB 104.

The contacting part 22 especially the arms 48 that converge to each other contact the tab 106a when fully mated.

Each of the plurality of tabs 106 may protrude inside the housing 2 but not touch the base 34 of the contacting part 22 of each terminal 18a. In another embodiment, the solder tab 106a may abut to the base 34 of the contacting part 22 as well.

The retainer element 46 with the elastically deflectable arms 48 on opposing sides 4 of the housing 2 may comprise a set distance 118 between the two arms 48. The latches 54 or noses may protrude towards the other arm 48.

When mating the electrical connector 1 to the PCB 104, that means when inserting the arms 48 into the retainer recesses 114, the arms 48 may be deflected by the tapered latch 54 that abuts with the PCB 104 or the inner wall 120 of the retainer recesses 114 of the PCB 104. When further inserting the electrical connector 1, the arms 48 snap back into their original position abutting to the inner wall 120 of the retainer recess 114.

The nose 54 can abut to the flat side 116 of the PCB 104 when trying to pull the electrical connector 1 away from the PCB 104, holding the electrical connector 1 in place until the electrical connector 1 is released by pushing the two release ends 62 towards the housing 2 to elastically deflect the elastically deflectable arms 48 outwards again to let the nose 54 pass through the retainer recess 114.

FIG. 12 shows a sectional view of the electrical connector assembly 100. The tab 106 is placed, for example soldered, onto the PCB 104. The retainer element 46 or at least a nose 54 of the retainer element 46 or of the extension 48 protrudes under the PCB 104 on a flat side 116.

FIG. 13 shows the electrical connector assembly 100 in an unmounted state 122. The PCB 104 comprises retainer recesses 114 for each arm 48 of the retainer element 46. The solder tabs 106a are distanced from each other with the same distance 124 which equals the distance 126 of the plurality of terminals 18 from each other in a direction 20 perpendicular to the longitudinal direction 16. The TPA 78 holds the terminals 18a in place and ensures that the terminals 18a are placed correctly within the housing 2. The two cylindrical protrusions 68 of the other retainer element 46 protrude along the longitudinal direction 16 of the terminals 18a and are not used when mating this way case.

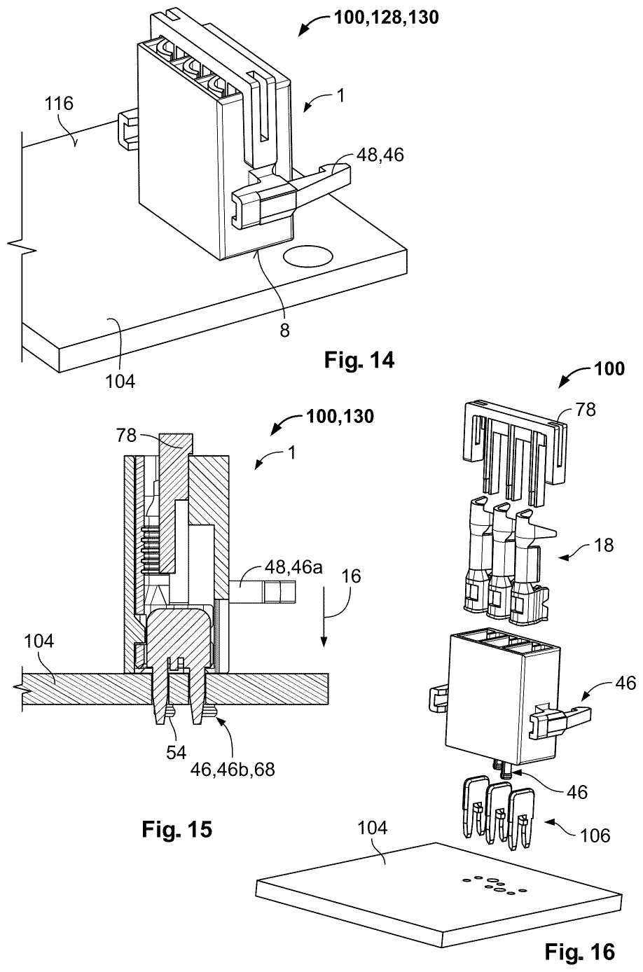

FIGS. 14 to 17 show an embodiment of the electrical connector assembly 100 that is vertically mounted to the PCB 104.

In FIG. 14 the electrical connector assembly 100 is shown in a mounted state 128. The electrical connector 1 is vertically mounted in a vertical mounted position 130, which means that a narrow side 8 of the electrical connector 1 lies flat on the flat side 116 of the PCB 104 and abuts with the flat side 116 of the PCB 104. In this case, the two elastically deflectable arms 48 of the one, for example the first, retainer element 46a are not in use.

In FIG. 15 the other, for example the second, retainer element 46b is inserted into the PCB 104 and the latches 54 of each cylindrical protrusion 68 of the retainer element 46 holds the electrical connector 1 in place so that the electrical connector 1 cannot be removed in the direction opposite the mating direction 16 without pushing the two elastically deflectable arms 48 of each cylindrical protrusion 68 to release the electrical connector 1.

FIG. 16 shows an exploded view of the electrical connector assembly 100 with the PCB 104 and the plurality of tabs 106 to be soldered onto the PCB 104, and the electrical connector 1 with retainer elements 46 and a plurality of terminals 18 that may comprise a TPA 78.

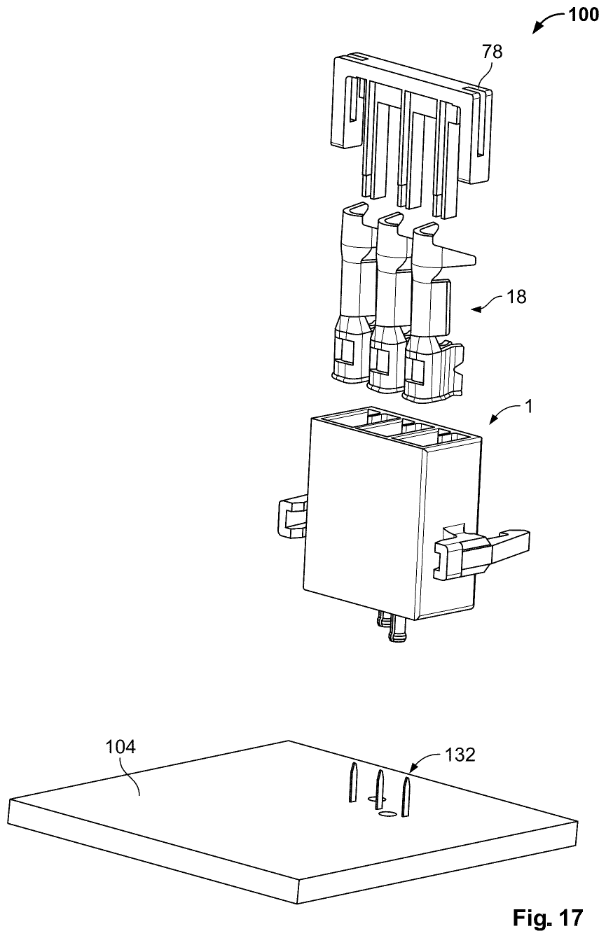

FIG. 17 shows a PCB 104 with an alternative embodiment with round pins 132 instead of solder tabs 106, which may also be used to mate the electrical connector 1 to the PCB 104.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An electrical connector for mating with a PCB, comprising
a housing and
a plurality of terminals arranged within the housing, wherein
each terminal of the plurality of terminals comprises
a contacting part that is configured to contact a tab that is located on the PCB, and
a terminating part that is configured to terminate a wire,
and wherein
the housing comprises
a plurality of connection openings that is configured to enable access to the plurality of terminals from outside the housing from two different directions.

2. The electrical connector according to claim 1, wherein two connection openings are assigned to each terminal.

3. The electrical connector according to claim 1, wherein the housing is cuboidal.

4. The electrical connector according to claim 1, wherein the plurality of connection openings is located on at least one side of the housing.

5. The electrical connector according to claim 1, wherein the housing comprises a plurality of insertion openings to insert the plurality of terminals.

6. The electrical connector according to claim 1, wherein the electrical connector comprises a retainer element to hold the electrical connector on the PCB.

7. The electrical connector according to claim 6, wherein the retainer element comprises at least two elastically deflectable extensions that protrude in a mating direction.

8. The electrical connector according to claim 6, wherein each elastically deflectable extension comprises a latch to hold the electrical connector to the PCB.

9. The electrical connector according to claim 6, wherein the retainer element comprises a release end to release the electrical connector from the PCB.

10. The electrical connector according to claim 6, wherein with a second retainer element, wherein the second retainer element is located on a different side of the housing than the first retainer element.

11. The electrical connector according to claim 1, wherein the electrical connector comprises a polarization pin that protrudes towards the PCB to prevent wrong mating.

12. The electrical connector according to claim 1, wherein the electrical connector comprises a TPA to ensure that the plurality of terminals are fully inserted into the housing.

13. The electrical connector according to claim 1, wherein
the contacting part comprises a base connecting two parallel arms extending from the base, wherein
the two arms converge as they extend further, and wherein
the ends of the two arms flare outwards again.

14. An electrical connector assembly with an electrical connector according to claim 1, with a plurality of wires, a PCB and a plurality of tabs.

15. The electrical connector assembly according to claim 14, wherein each of the plurality of tabs comprises a rectangular connection portion.
